(19) United States
(12) Patent Application Publication
(10) Pub. No.: US 2003/0113252 A1
(43) Pub. Date: Jun. 19, 2003

(54) Method for alkali hydride formation and materials for hydrogen storage

(75) Inventors: Ping Chen, Singapore (SG); Zhitao Xiong, Singapore (SG); Jizhong Luo, Singapore (SG); Jianyi Lin, Singapore (SG)

Correspondence Address: KLARQUIST SPARKMAN, LLP, One World Trade Center, Suite 1600, 121 S.W. Salmon Street, Portland, OR, 97204, US

(73) Assignee: National University of Singapore

(21) Appl. No.: 10/286,120

(22) Filed: Oct. 31, 2002

Related U.S. Application Data
(60) Provisional application No. 60/330,803, filed on Oct. 31, 2001.

(51) Int. Cl. C01B 31/00; H01M 4/58; C01B 6/04

(52) U.S. Cl. 423/414; 423/644; 429/218.2

(57) ABSTRACT

Alkali metal-carbon compounds may be formed by mixing an alkali metal with carbon. Such alkali metal-carbon compounds absorb hydrogen at lower temperatures and may be useful as hydrogen storage materials in various applications, such as in hydrogen fuel cells.

This application is related to U.S. Provisional Patent Application Serial No. 60/330,803, filed Oct. 31, 2001, entitled “Method for alkali hydride formation and materials for hydrogen storage”, the contents of which are hereby incorporated by reference.

### FIELD OF INVENTION

This invention relates to a method of synthesis of alkali metal hydrides. The present invention also relates materials for hydrogen storage.

### BACKGROUND OF THE INVENTION

Lithium hydride is widely used in military, fuel cell and buoyancy device as hydrogen generator. The use of this compound is very efficient since 7.95 grams of LiH reacted with water yields 2.02 grams of hydrogen [1]. The hydrogen density in weight is 12.5 wt %, which is almost the highest in metal hydrides. The volume density is 112.5 g/l, which is 40% higher than cryogenic H₂ storage. The energy density of LiH is 4.16 kWh/Kg or 3.74 kWh/l, which also is one of the highest among metal hydrides. LiH is also a commercially used agent in organic synthesis [2]; a cooling agent in primordial gas [3]; and, a candidate in chemically storing solar energy [4]. KH normally works as initiator for organic synthesis [5].

Lithium hydride is normally prepared by the reaction of molten lithium and hydrogen at temperature above 600° C. Industrially, lithium metal is heated up to high temperature to initiate its reaction with hydrogen then the reaction can be maintained and continued spontaneously at practical rate until the synthesis is complete. In the laboratory, the hydrogenation of lithium is carried out in an iron container at temperature above 600° C. [6]. The conventional preparation method of KH was by reacting molten K with hydrogen at temperature higher than 200° C.

Hydrogen-based energy is the cleanest energy source and will play a great part in the energy construction in this century. Development of hydrogen storage medium is of great importance and research on this area is quite active throughout the world.

Nowadays, there are four systems for hydrogen storage [7,8]: Liquid hydrogen; Compressed hydrogen gas; Cryo-adsorption system; and, Metal hydride system.

Applications of hydrogen in pure form (liquid hydrogen or compressed hydrogen gas) are mostly for large-scale or stationary purposes, for the weight of containers normally sacrifices a lot to the whole hydrogen storage capacity if hydrogen is used in limited scope. For vehicular or any other portable applications, hydrogen stored in solid-state materials seems to be the only solution. Thus, cryo-adsorption system and metal hydride systems are the two promising ways.

The cryo-adsorption systems show advantages in moderate weight and volume. In this system, hydrogen molecules are physically bound to the surface of activated carbon at liquid nitrogen temperature. Under optimized conditions, the hydrogen storage capacity by activated carbon may achieve 7 wt %. The disadvantages of this system relate to the critical conditions required (cryogenic conditions).

Metal hydrides are the commonly used systems for hydrogen storage. Hydrogen is chemisorbed by metal or metal alloys to form corresponding metal hydrides. The advantages of this system are that the absorbing or desorbing of hydrogen is carried out under moderate conditions (temperature & pressure). The hydrogen storage capacity in terms of volume is relatively high. The disadvantages of this system are the expensive material, slow kinetics and the low storage capacity in terms of weight.

The recent trend for material designation is the searching for carbon-based materials. Carbon fibres, carbon nanotubes, activated carbon and fullerenes, etc. are considered as candidates for this purpose. Numerous papers have been published [9-13], but until the present invention, the hydrogen storage capacity in these materials has never met practical criteria.

### BRIEF SUMMARY OF THE INVENTION

According to one aspect of the invention, there is provided a method of forming an alkali metal-carbon compound comprising mixing carbon with an alkali metal.

According to another aspect of the invention, there is provided a method for synthesizing an alkali metal hydride comprising contacting an alkali metal-carbon compound with hydrogen.

According to third aspect of the invention, there is provided a method of storing hydrogen comprising contacting an alkali metal-carbon compound with hydrogen to form a composition comprising alkali metal, carbon and hydrogen.

According to a fourth aspect of the invention, there is provided a hydrogen storage material comprising a composition comprising alkali metal, carbon and hydrogen.

Alkali metals are elements listed in Group I of the Periodic Table of Elements, for example, lithium (Li), sodium (Na), potassium (K) or cesium (Cs). Li and K are preferred.

Carbon material may be used in any form, for example, graphite, carbon nanotubes, carbon powder, activated carbon, carbon fibres or carbon nanofibers.

The molar ratio of alkali metal to carbon in the alkali metal-carbon compound is preferably from about 5000:1 to about 1:200, more preferably from about 1000:1 to about 1:100, even more preferably from about 500:1 to about 1:50, and yet more preferably from about 500:1 to about 1:24.

Alkali-carbon compounds (“Alkali-C compounds”) preferably refer to alkali metal-C intercalation compounds. For example, compounds of formula of LiC₆, LiC₁₂, LiC₂₄, KC₈, KC₂₄, etc.

When alkali-C compounds are exposed to a hydrogen-containing atmosphere the alkali-C compounds absorb hydrogen. Surprisingly, hydrogen absorption in a process of the present invention occurs at a lower temperature than in processes of the prior art. A process of the present invention is performed preferably at a temperature from about 0° C. to about 700° C., more preferably from about 25° C. to about 600° C., even more preferably from about 50° C. to about 500° C., yet more preferably from about 50° C. to about 300° C. Also, the process is preferably performed at a pressure from about 0.1 atm to about 100 atms, more preferably from about 0.1 atm to about 50 atms, even more preferably from about 1 atm to about 50 atms. Alkali metal hydride is formed in the process. Hydrogen storage of more than 10 wt % may be achieved, particularly in Li—C systems.

The desorption of hydrogen from the hydrogenated alkali-C systems can be achieved either by heating the materials at temperature range from 0 to 1200° C., preferably from 100° C. to 1000° C. or by hydrolysis of the material with water.

Additional features and advantages of the invention will be set forth in the description that follows, and in part will be apparent from the description or may be learned by practice of the invention. These variations are considered to be in the scope of the invention. The objects and other advantages of the invention will be realized and attained by the structure particularly pointed out in the written description and claims hereof as well as the appended drawings.

### BRIEF DESCRIPTION OF THE DRAWINGS

FIG. 1 is the Low-Content Temperature-Programmed-Reduction spectra of: (a) Li-graphite mixture with Li/C=10/1; (b) Pure Li. The temperature was raised from room temperature to 700° C. at 10° C./minute.

FIG. 2 is the Pressure-Composition-Isotherm (PCI) results of Li-graphite mixture with Li/C=7/2. The operating temperature is 184° C.; the weight of Li+C is 360 mg.

FIG. 3 is the Intelligent-Gravimetric-Analyzer (IGA) spectrum of Li—C mixture with Li/C=10/1. The temperature was raised from room temperature to 250° C. at 5° C./minute; hydrogen pressure is 6 atms.

FIG. 4 is the PCI result of K-graphite material at 120° C. with K/C=1/1. Sample weight is ˜1.0 gram.

FIG. 5 is the in situ XRD patterns of Li—C mixture with Li/C=10/1. (a) Li—C as prepared, (b) Li—C mixture after PCI operation (hydrogenation at 180° C.). The peaks marked with * belong to LiH; peak marked with # is graphite, marked with ˆ is LiC₆ and LiC₁₂, marked with X is Li metal. Others are Li₂O and LiOH as well as substrate Pt.

### DETAILED DESCRIPTION OF THE INVENTION

Alkali metals are among the most active metals. Alkali metals are easily oxidized if exposed to air under ambient conditions. The commercially supplied alkali metals are unavoidably coated with compact oxides or hydroxides. Thus, the operation of alkali metals is preferably conducted under inert atmosphere. Mixing and pre-treatment of alkali metals and carbon are preferably carried out under inert gas atmosphere, for example, under an inert gas such as Ar or He, among others.

On a bench scale, an inert atmosphere may be provided, for example, in a glove box. Sample transfer from the glove box to containers in a testing machine is ideally performed as quickly as possible.

In the present invention, a certain amount of carbon is preferably added into the alkali metal, for example, lithium or potassium. Pre-treatment of the alkali-C mixture preferably includes: mixing the carbon and alkali metal, and then pressing the carbon and alkali metal together. Mixing of alkali metal and carbon may be done in a variety of ways, for example, by pounding the carbon into the alkali metal using a mortar and pestle or by milling the carbon and alkali metal in a mill such as a ball mill. Preferably, the mixture is made as homogeneous as possible. The mixing is preferably done under inert gas atmosphere. Pressing the mixture is preferably done under a pressure of from about 1 atm to about 10,000 atms.

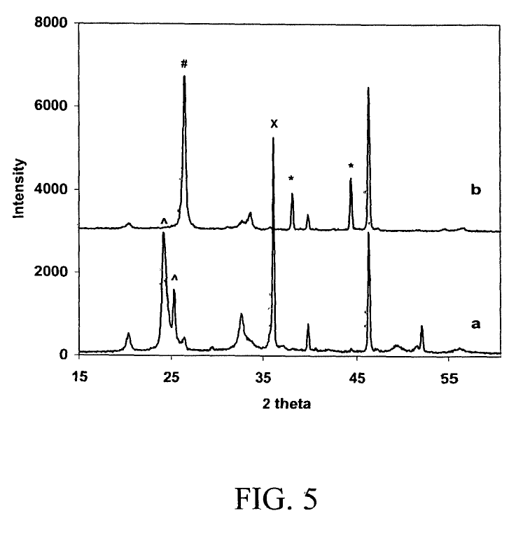

Without being held to any theory, it is believed that interactions between alkali metal and C occur during pre-treatment. Interaction between alkali metal and C could result in two categories of compounds being formed: 1) alkali-C intercalated compounds; and, 2) alkali metal-carbides. For example, lithium carbides, Li₂C₂ or LiC, possess the face-centred structure, which is different from Li and C. Alkali metal carbides are usually prepared by decomposition of C₂H₂ in the present of alkali metal at a temperature around 300° C. or by calcinations of alkali metal and C at elevated temperature. In the present invention, the alkali-C compound found in the alkali metal-C mixture is an alkali metal-C intercalation compound. For example, as shown in FIG. 5a, the XRD characterization of an as-prepared Li—C mixture demonstrates that there exist LiC₆, LiC₁₂, LiC₂₄ and lithium metal as well as minor amounts of Li₂O & LiOH. Pure carbon structure is very weak. The Li—C intercalation compounds possess a similar layer structure as that of graphite but with broadened layer inter-space, i.e., the interlayer distance of LiC₆ and LiC₁₂ is 0.370 nm and 0.35 nm, respectively. Potassium also forms K—C intercalation compounds, for example, with formulae KC₈, KC₂₄ etc. Like Li—C interaction compounds, the K—C intercalation compounds also possess layer structure with even broader interlayer distance (˜0.51 nm).

The mixing and pressing of carbon into alkali metal at ambient temperature and inert gas atmosphere preferably results in the formation of a series of alkali-C intercalation compounds. The method of forming alkali-C intercalation compounds of the present invention is different from traditional methods in which alkali metal-C (e.g. Li—C or K—C) intercalated compounds are synthesized, for example, by reacting evaporated Li or K with carbon at high temperature or by heating the alkali-C mixture at high temperature under high pressure.

In the present invention, carbon materials of any form may be used, and are preferably at least one selected from the group consisting of graphite, carbon nanotubes, carbon fibres, carbon nanofibers, carbon powders, fullerenes and activated carbon. Graphite, carbon powder, activated carbon, fullerenes and carbon fibres are commercially available. Carbon nanotubes and nanofibers can be obtained accordingly the previously reported methods [10].

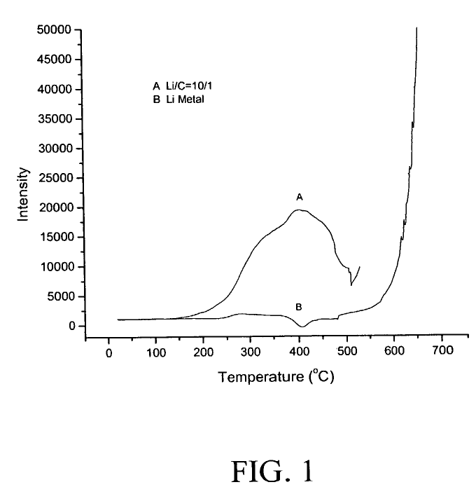

Without being bound by any theories, the formed alkali-carbon intercalated compound seems to be a catalyst for the hydrogenation of alkali metal. As illustrated by Low-Content Hydrogen Temperature-Programmed-Reaction (LC-TPR) (FIG. 1), on which diluted H₂ (10% H₂+90% Ar) was used as reacting gas, the hydrogen absorption by Li—C (for instance) occurred at temperature lower than 150° C.; for pure lithium, the apparent hydrogenation began at temperature around 550° C.

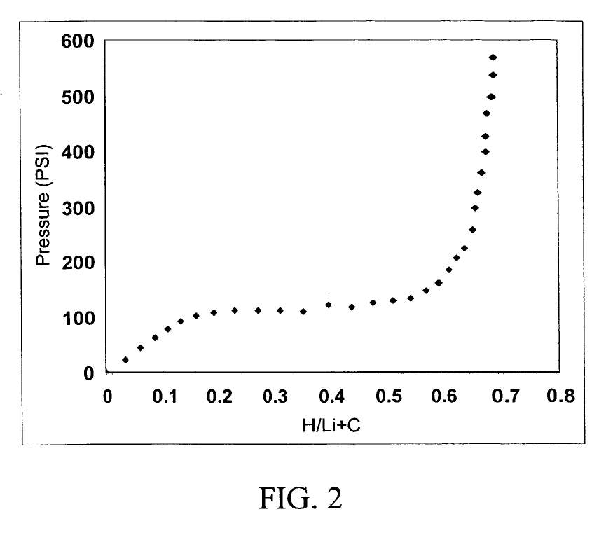

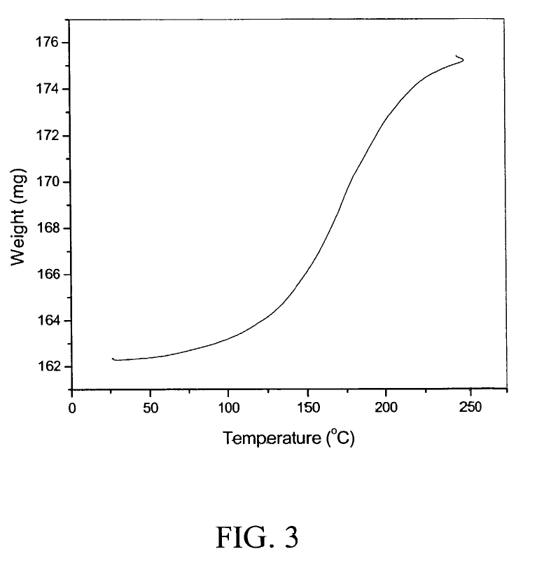

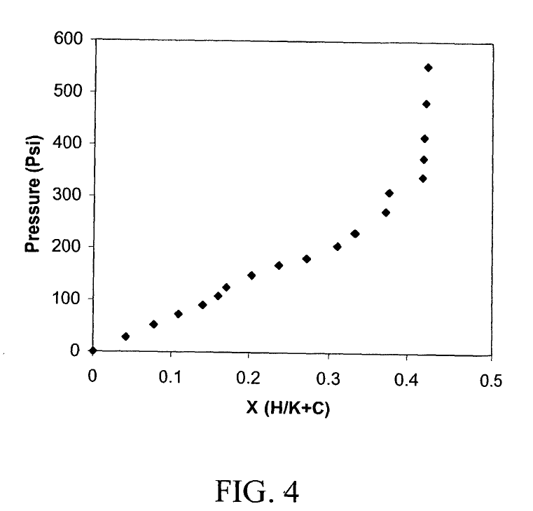

The degree and rate of hydrogenation of alkali metal in the presence of carbon seems related to hydrogen pressure. The LC-TPR was conducted under a hydrogen pressure of around 1.0 atm, and the hydrogen absorption peak was comparatively weak. To clarify the relationship between hydrogenation degree and pressure, we performed Pressure-Composition-Isotherm (PCI) measurement at 180° C. for Li—C system and 120° C. for K—C system. PCI is the commonly used method in evaluation of hydrogen storage capacity in metals or metal alloys. It measures the pressure changes during hydrogen absorption and desorption. The PCI results of Li—C sample are illustrated in FIG. 2. It can be seen that the absorption line possesses characteristics similar to the characteristics of metals, which can form metal hydrides. In the pressure range of 0 to 100 PSI, the molar ratio of H/(Li+C), referred to as X, increased linearly and reached 0.15. During that pressure range, absorbed hydrogen diffused into the lattice of lithium and formed random Li—H solid solution. As pressure reached 100 PSI, which is called the plateau pressure, the H/(Li+C) increased to 0.55 with pressure almost unchanged. After that, the H/(Li+C) further increased to 0.7 with pressure increase to 550 PSI. Converted to the hydrogen storage capacity, the molar ratio of H/(Li+C)=0.7 is equal to 9 wt %. Intelligent-Gravimetric-Analyzer (IGA), which also confirmed this result (see FIG. 3), measured the weight variation of hydrogen absorbed (in mg) during hydrogenation under 6 atms and at temperature from 25° C. to 250° C. The PCI measurement of K—C system conducted at 120° C., as shown in FIG. 4, shows that X could reach 0.43, which means that 80% of K is hydrogenated.

The XRD measurements were done on the as-prepared Li—C (FIG. 5a) and Li—C mixture after hydrogenation (FIG. 5b). It is clear that after hydrogen absorption at 180° C., almost all Li metal was converted to LiH, and the Li—C intercalation compounds, i.e. LiC₆ (situated at ˜2θ=24°) and LiC₁₂ (2θ=25.2°) etc. disappeared and a pure graphite phase (2θ=26.2°) was developed. This result further demonstrates that with the addition of carbon, LiH can be successfully synthesized at a temperature lower than 200° C.

The alkali/C molar ratio may be adjusted to include more or less carbon. More carbon added will accelerate the hydrogenation rate, compromising hydrogen absorption capacity if the whole alkali-C mixture is considered as sorbent. Less carbon will increase the hydrogen storage capacity even up to over 12 wt % (e.g. for Li—C system, a hydrogen storage capacity of about 12.5% has been achieved) but the hydrogen absorption rate is relatively slow.

The following specific examples are provided to illustrate the invention. It will be understood, however, that the specific details given in each sample have been selected for purpose of illustration and are not to be construed as a limitation on the invention. Generally, the experiments were conducted under similar conditions unless noted.

### EXAMPLES

### Example 1

60 mg graphite was mixed with 350 mg lithium metal, and then the mixture was pounded with a pestle as homogeneously as possible. After that, the pounded mixture was pressed into pellets for testing. 300 mg of the above pellets were put into a PCI sample container for Auto-soak measurement at 180° C. and 30 atms of pure hydrogen. After 3 hours of absorption, 33 mg of hydrogen was absorbed. The XRD measurements show that the product only has LiH, graphite and weak Li₂O phases.

### Example 2

120 mg of graphite was mixed with 250 mg lithium metal then the same procedure described in Example 1 was followed. About 30 mg of hydrogen was absorbed with hydrogen storage capacity of 8.1 wt %.

### Example 3

240 mg of graphite was mixed with 140 mg of lithium metal, then the same procedure as Example 1 was followed. 4 wt % of hydrogen was absorbed.

### Example 4

60 mg of multi-walled carbon nanotubes (with average diameter of 20 nm) was mixed with 350 mg lithium metal, then the same procedure as describe in Example 1 was followed except that the absorbing temperature was changed to 160° C. About 4 wt % of hydrogen was absorbed. When the absorbing time was prolonged for 12 hours, 9 wt % of hydrogen was absorbed.

### Example 5

60 mg of activated carbon was mixed with 350 mg of lithium, then the same procedure as described in Example 1 was followed except that absorbing time was 6 hours. 9 wt % of hydrogen was absorbed.

### Example 6

240 mg of graphite was mixed with 780 mg of potassium metal, then the same procedure as described in Example 1 was followed except that K—C was exposed to hydrogen atmosphere at 120° C. for 4 hours. About 1.5 wt % of hydrogen was absorbed.

To those skilled in the art, it is to be understood that many changes, modifications and variations could be made without departing from the spirit and scope of the present invention as claimed hereinafter.

### References

1. G. K. Pitcher and G. J. Kavarnos, Int. J. Hydrogen Energy, 22 (6), 575 (1997).

2. P. Brandt, Acta Chem. Scand. 3, 1050(1949).

3. M. Bellini, P. De Natale and M. Inguscio, J. Astrophys, 424, 507(1994).

4. M. Lehner and M. Jungen, Sol. Energy, 47, 279 (1991)

5. A. Stolarzewicz, D. Neugebauer and J. Grobelny, Macromole. Rapid Comm., 17, 787 (1996).

6. E. Zintl and A. Harder, Z. Phys. Chem. (B) 14, 265(1931).

7. H. Buchner, P. Pelloux-Gervais, M. Mullar, F. Grafwallner and P. Luger. Hydrogen and other alternative fuels for air and ground transportation. H. W. Pohl, Eds. (John Wiley & Sons, Chichester 1995). Chaps. 7-11.

8. J. Nitsch, W. Peschka, W. Schnurnberg, M. Fischer and H. Eichert. Hydrogen as an energy carrier. C. Winter and J. Nitsch, Eds. (Springer-Verlag. Berlin, 1988), Part B.

9. A. C. Dollin, K. M. Jones et al, Nature, 386, 377 (1997)

10. A. Chambers, C. Park and R. T. K. Baker, J. Phys. Chem. B, 102, 4253 (1998).

11. V. Meregalli and M. Parrinello, Appl. Phys. A, 72, 143 (2001).

12. A. C. Dollin and M. J. Heben, Appl. Phys. A, 72, 133 (2001).

13. P. Chen, HB. Zhang, et al, Carbon, 35, 1495 (1997).

1. A method for synthesis of an alkali hydride comprising adding carbon into an alkali metal to form an alkali-C compound of the alkali metal, then exposing the alkali-C compound to a hydrogen containing atmosphere at a temperature from 25 to 600° C. and a pressure of 0.1 to 100 atms.

2. The method of claim 1, wherein the alkali metal is lithium or potassium.

3. The method of claim 1, wherein the carbon is in the form of graphite, carbon powder, carbon fibres, carbon nanotubes, a fullerene, or activated carbon.

4. The method of claim 1, wherein the alkali-C compound is an alkali-C intercalated compound with formula of LiC₆, LiC₁₂, LiC₂₄, KC₈ or KC₂₄.

5. The method of claim 4, wherein the alkali-C intercalated compound is formed by pounding carbon with alkali metal under inert gas atmosphere then pressed into pellets under pressure from 1 atm to 10000 atms.

6. The method of claim 5, wherein the inert gas is Ar or He or a mixture of them.

7. The method of claim 1, wherein the alkali metal and the carbon are in a molar ratio of from 5000/1 to 1/200.

8. The method of claim 7, wherein the molar ratio is from 500/1 to 1/24.

9. A method for storing hydrogen comprising exposing a solid sorbent comprising an alkali metal-carbon-based material to a hydrogen atmosphere at temperature of from 25 to 700° C. under 0.1 to 100 atms pressure.

10. The method of claim 9, wherein the metal is lithium or potassium.

11. The method of claim 9, wherein the carbon is in the form of graphite, carbon powder, carbon fibres, carbon nanotubes, a fullerene or activated carbon.

12. The method of claim 9, wherein carbon is pounded with alkali metal in an inert gas atmosphere then pressed into pellets under pressure from 1 atm to 10000 atms to form an alkali-C absorbent.

13. The method of claim 8, wherein the alkali metal and the carbon are in a molar ratio is from 5000/1 to 1/200.

14. The method of claim 13, wherein the molar ratio is from 500/1 to 1/24.
